(19) United States
(12) Patent Application Publication
(10) Pub. No.: US 2024/0058804 A1
(43) Pub. Date: Feb. 22, 2024

(54) REGENERATION TOWER FOR CONTINUOUS CATALYTIC REFORMING PROCESS

(71) Applicant: UOP LLC, Des Plaines, IL (US)

(72) Inventors: Bryan J. Egolf, Crystal Lake, IL (US); Jeffrey R. Grott, Chicago, IL (US); Ka L. Lok, Buffalo Grove, IL (US); Michael J. Vetter, Schaumburg, IL (US); Vikasbhai Gangarambhai Sankalia, Gurgaon (IN)

(21) Appl. No.: 18/315,683

(22) Filed: May 11, 2023

Related U.S. Application Data
(60) Provisional application No. 63/371,946, filed on Aug. 19, 2022.

(51) Int. Cl. B01J 38/02; B01J 38/42

(52) U.S. Cl. CPC B01J 38/02; B01J 38/42; B01J 2219/1946; B01J 2219/1943; B01J 2219/00981

(57) ABSTRACT

The regeneration tower with a cylindrical section and a conical section has a tertiary screen covering an opening in the conical section which prevents any catalyst that escapes from the cylindrical catalyst bed or the catalyst bed in the conical section from entering the oxygen-rich chlorination zone. The regeneration tower may also have one or more additional changes. The length of the cylindrical section can be increased. The inner screen in the cylindrical section may comprise punch plate or slotted plate. A secondary screen can be added in front of the inner screen in the cylindrical section.

This application claims priority to U.S. Provisional Patent Application Ser. No. 63/371,946 filed on Aug. 19, 2022, the entirety of which is incorporated herein by reference.

### BACKGROUND

The regeneration tower for a continuous catalytic reforming (CCR) process includes inner and outer screens as well as a cylindrical section at the top of the inner screen. Currently, the inner and outer screens and the cylindrical section are fabricated from profile wire with support rods. Currently, the low oxygen level regeneration gas flow in the burn zone bed is radial flow from the outer screen to the inner screen. The oxygen rich makeup gas is upflow from the chlorination zone to the interior of the inner screen through the opening in the bottom of the inner screen. The inner and outer screens contain the catalyst and form a catalyst bed. In this construction, most of the strength of the screen comes from the support rods.

Currently the low oxygen level regeneration gas flow from the outer screen to the inner screen is typically about 350 to 550° C. The temperature of the spent catalyst arriving at the top the annular catalyst bed in the burn zone is typically 20 to 250° C. When the low temperature downward moving spent catalyst mixes with high temperature radial regeneration gas at the top of the burn zone, a temperature transient condition occurs. Since the regeneration gas is radial flow toward to the inner screen, the inner screen is subjected to the transient temperature condition. The variations of the regeneration gas flow rate, regeneration gas temperature, spent catalyst flow rate, and spent catalyst temperature entering this mixing zone at the top of the annular catalyst bed forms a dynamical thermal transient which is the thermal cycle zone. The dynamical thermal transient is comprising of both circumferential temperature gradient around the annular catalyst bed and inner screen and a temperature gradient along the catalyst bed and inner screen from top to bottom. The thermal cycle zone locates at the upper section of the annular catalyst bed which is sandwiched by the outer screen and the cylindrical section of the inner screen at the top of the burn zone.

As downflow catalyst flows down from the top of the burn zone toward to the Chlorination zone, coked catalyst is combusted by the oxygen generating heat of coke combustion which stabilizes the dynamics of the thermal transience. The non-thermal cycle locates below the thermal cycle zone. The annular catalyst bed in the non-thermal cycle zone is sandwiched by the outer screen and conical section of the inner screen and it locates below the thermal cycle zone in the burn zone.

The upper cylindrical section is relatively short (e.g., 6″). This short section at the top of the inner screen is subject to burn zone gas, seal gas, and catalyst.

The cylindrical section has sometimes been subject to damage, typically damage to the profile wires (fisheye), separation of the support rods from the profile wires, and separation of the support rods and profile wires from the connections on the upper and lower ends of the cylindrical section where it welds to the connection rings. Damage may occur at weld splices and weld locations.

In addition, loss of catalyst containment in CCR units because of damage to the profile wire and support rods allows coked catalyst to fall into the oxygen-rich chlorination zone, leading to temperature excursion which can result in damage to the regeneration tower and/or permanent catalyst damage, which results in fouling of the CCR regeneration tower inner screen and equipment in the unit.

Therefore, there is a need for a more robust regeneration tower construction and catalyst containment.

### BRIEF DESCRIPTION OF THE DRAWINGS

FIG. 1 is an illustration of one embodiment of a regeneration tower.

FIG. 2 is an exploded view of a portion of the regeneration tower of FIG. 1.

FIG. 3 illustrates a portion of FIG. 1 with catalyst buildup on the tertiary screen.

FIG. 4 illustrates an alternate embodiment of the tertiary screen with catalyst buildup on the tertiary screen.

FIGS. 5-9 are illustrations of different types of tertiary screens.

FIG. 10 illustrates an embodiment of a portion of the regeneration tower including a sensor.

### DESCRIPTION

The present invention addresses the problems associated with damage to the screens in the regeneration tower.

The regeneration tower may contain a cylindrical section and a conical section. The cylindrical section has inner and outer screens defining an annular catalyst bed between them. The conical section is below the cylindrical section. The conical section has an outer screen and a tapered inner screen defining a catalyst bed between them. The annular catalyst bed is connected to the catalyst bed in the conical section. There is a tertiary screen covering an opening in the conical section defined by the tapered inner screen. The opening is a circular cross-section of the tapered inner screen perpendicular to the center line of the conical section. This opening allows the makeup air to communicate from the oxygen-rich chlorination zone to the burn zone through the interior of the inner screen so that it supplies oxygen to burn the coked catalyst in the burn zone. The tertiary screen prevents any catalyst that escapes from the annular catalyst bed in the cylindrical section or the catalyst bed in the conical section from entering the oxygen-rich chlorination zone and allows the makeup air to communicate from the oxygenation zone to the interior of the inner screen. It can be located in the reheat zone or at the bottom of the burn zone.

The tertiary screen can take a variety of configurations. Suitable configurations include, but are not limited to, flat screens, concave screens, or convex screens, with or without a chimney.

The tertiary screen can be made of any suitable screen material. Suitable screen materials include, but are not limited to, wire mesh, profile wire screen, perforate plate, punch plate, or slotted plate.

An optional aspect of the improved regeneration tower involves increasing the length of the cylindrical catalyst bed. The length of current beds is typically approximately 15 to 16 cm. Elongating the cylindrical section increases the catalyst residence time. The length of the cylindrical section may be in the range of 1.2 to 120 cm. or 40 to 75 cm, or 45 to 60 cm. The width of the annular catalyst bed in the cylindrical section may be in the range of 7 to 50 cm, or 7 to 40 cm, or 7 to 30 cm, or 7 to 20 cm, or 7 to 1.8 cm, or 10 to 50 cm, or 10 to 40 cm, or 10 to 30 cm, or 10 to 20 cm, or 12 to 50 cm, or 12 to 40 cm, or 12 to 30 cm, or 12 to 20 cm. The catalyst volume in the cylindrical section is defined by the length of the cylindrical section and the catalyst bed depth. Another way to determine the length of the cylindrical catalyst bed is to base on a portion of the volumetric flow of the catalyst on a one hour basis for a given catalyst bed depth when the CCR is in a continuous catalyst circulation condition. The cylindrical catalyst bed volume is defined by the length, of the cylindrical section and the bed depth (i.e., the distance between the inner and outer screens). The portion of catalyst volume in the cylindrical section may be in the range of 2 to 15%, or 2 to 10%, or 3 to 15%, or 3 to 10% of volumetric catalyst circulation rate on a one hour basis. For example, if the CCR circulation rate is 30 m³/hr, the cylindrical bed should have a volume between 6 to 9 m³/hr.

In some embodiments, the ratio of the length of the inner screen to the width of the annular catalyst bed in the cylindrical section is in a range of 1:1 to 10:1, or 1:1 to 5:1, or 1:1 to 3.75:1.

The thermal cycle zone in the regeneration tower is at the top of the burn zone and it migrates downward with an increase in inner screen plugging. The weld ring the transition from the cylindrical section and the conical section) is sensitive to the thermal temperature cycle condition and could fail, Moving this weld ring to a lower elevation would allow sufficient residence time in the cylindrical zone to dampen the thermal cycle for the weld ring.

Another aspect is increasing the strength of the cylindrical section. The profile wire/support rod construction of the cylindrical section of current regenerators requires numerous welds for each connection between each profile wire and support rod. Any one of these welds which does not have sufficient connection is a point of failure. Replacing it with punch plate or slotted plate in some embodiments significantly reduces the number of welds and reduces the number of possible failure points. The strength of the cylindrical section will come from the thickness of the slotted plate, which can be of varying thickness and varying slot sizes/widths/lengths/depths.

Circumferential stiffeners could be welded to the inside of the slotted plate to increase the strength. This weld would be very robust because the stiffener would be fully welded to the solid portion of the slotted plate. Currently, the analogous weld is the attachment weld between the profile wire and the support rod.

The thickness of the plate may be constant or it may vary. For example, the plate may have a thickness in the range of 2 mm to 12 mm.

The plate can have a first portion with slots and a second portion without slots. The first portion could have a thickness of about 2 mm-8 mm, and the second portion could have a thickness of about 8 mm-20 mm. The second portion is the blankoff portion of the plate, which can be welded to the blankoff that is welded to the top head to isolate the inlet from the outlet.

The slots in the plate may be vertical or horizontal. Slots would likely be vertical to mimic the current profile wire slot arrangement but could be horizontal if required.

The slot diameter can vary from top to bottom to control the pressure drop across the slotted plate. The purpose would be to control the flow of the gas into this section of the inner screen.

The slots should be small enough on the catalyst facing side of the slotted plate to contain the catalyst. For example, with a catalyst which is approximately 1.6 mm diameter, the slots on the catalyst facing side will be less than 1.6 mm. The slot width does not have to be constant and may vary. The slot width on the catalyst facing side can be the same as or smaller than the slot width on the opposite of the slotted plate. The slots may be larger to help reduce plugging (similar to a triangular profile wire), or they could be smaller to aid in vapor distribution (however, this increases the pressure drop). The slots are manufactured by cutting the plate material from the inside, the outside, or both sides. The slots can be made by any suitable process. Suitable processes include, but are not limited to, laser cutting, water jet cutting, milling, or other machining process.

The slotted plate can be made in larger individual sections than is possible with the profile wire/support rod construction. The larger plate size reduces the number of weld splice joints which will increase reliability because weld splice joints have weaker mechanical strength in general. In some embodiments, there may only be two vertical weld splices and no horizontal splices.

The weld between the top of the inner screen open section and the inner screen solid upper blankoff may be eliminated in some embodiments. The slotted plate can incorporate the upper solid blankoff section in a one-piece construction, eliminating this weld, which will greatly increase the reliability of the device.

The solid plate construction will allow for more robust welding to the lower conical screen connection compared with welding numerous individual profile wires to the lower conical screen. This will greatly increase the reliability of the device.

In order to avoid coked catalyst from migrating to the chlorination zone, a secondary screen could be added on the center facing side of the inner screen. The secondary screen may comprise wire mesh.

Another aspect is avoiding coked catalyst combustion in the Chlorination Zone when the coked catalyst slips from the burn zone to the Chlorination Zone.

The chlorination zone is an oxygen rich environment because the upflowed makeup air contains an oxygen level typically in the range of 5 to 20%. As a result, combination of rich oxygen and coked catalyst may promote excessively high rate of coke combustion generating heat of combustion and carbon dioxide. This results in temperature excursion well exceeding 850° C. At elevated temperature, the catalyst bed in the chlorination zone will be thermally damaged. In addition, the internal components of the regenerator in the chlorination zone may be thermally damaged. Coked catalyst slippage from the annular catalyst bed in the burn zone to the chlorination zone could occur due to various conditions such as incomplete coke removal in the burn zone. This allows coke remaining on the catalyst pills greater than or equal to 0.2 wt. %, or in the range of coke to migrate to the chlorination zone from the burn zone, or 0.2 to 20 wt. %, or 0.2 to 15 wt. %, or 0.2 to 12 wt. %, or 0.2 to 10 wt. %, or 0.2 to 6 wt. %, or 0.2 to 5 wt. %, or 0.3 to 20 wt. %, or 0.3 to 15 wt. %, or 0.3 to 12 wt. %, or 0.3 to 10 wt. %, or 0.3 to 6 wt. %, or 0.3 to 5 wt. %, or 1 to 20 wt. %, or 1 to 15 wt. %, or 1 to 12 wt. %, or 1 to 10 wt. %, or 1 to 6 wt. %, or 1 to 5 wt. %, or 2 to 20 wt. %, or 2 to 15 wt. %, or 2 to 12 wt. %, or 2 to 10 wt. %, or 2 to 6 wt. %, or 2 to 5 wt. %, or 3 to 20 wt. %, or 3 to 15 wt. %, or 3 to 12 wt. %, or 3 to 10 wt. %, or 3 to 6 wt. %, or 3 to 5 wt. %, or 5 to 20 wt. %, or 5 to 15 wt. %, or 5 to 12 wt. %, or 5 to 10 wt. %, or 5 to 6 wt. %, or 6 to 20 wt. %, or 6 to 15 wt. %, or 6 to 12 wt. %, or 6 to 10 wt. %.

In order to avoid coked catalyst from migrating to the chlorination zone, an on-line carbon dioxide and/or oxygen sensor could be installed in the makeup air path between the burn zone and the chlorination zone. It could be located below the tertiary screen, in the reheat zone, or at the top of the chlorination zone The sample probe of the on-line carbon dioxide and/or oxygen sensor extracts the upflow make up air traveling from the catalyst bed of chlorination zone to the bottom of the burn zone entering the interior to inner screen. Since coked catalyst combustion forms carbon dioxide, the on-line carbon dioxide analyzer will detect abnormally high concentration of carbon dioxide in the makeup air when abnormal coked catalyst combustion occurs in the chlorination catalyst bed. This detection system could be integrated to automatic shutdown of the catalyst regeneration control system to prevent combustion of coked catalyst in the chlorination zone.

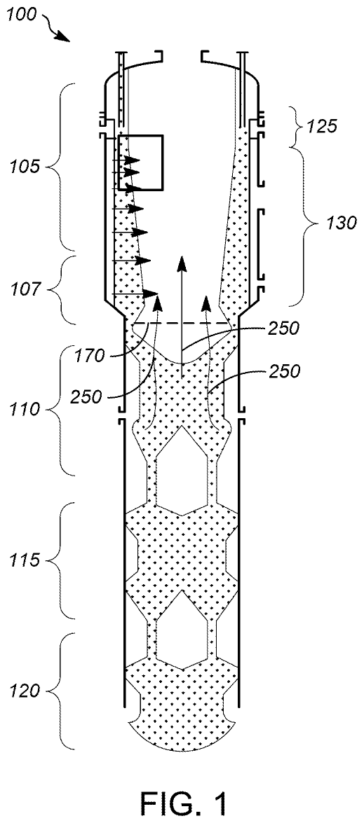

FIG. 1 illustrates one embodiment of a regeneration tower 100. The regeneration tower 100 includes a burn zone 105, a reheat zone 107, a chlorination zone 110, a drying zone 115, and a cooling zone 120.

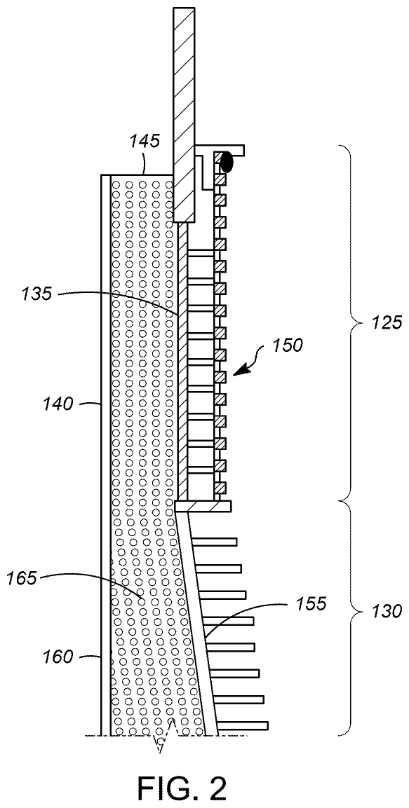

The regeneration tower 100 has a cylindrical section 125 and a conical section 130 as shown in FIGS. 1-2. The burn zone 105 includes cylindrical section 125 and part of the conical section 130. The reheat zone 107 comprises the remaining part of the conical section 130.

The cylindrical section 125 has an inner screen 135 and an outer screen 140 which define an annular cylindrical catalyst bed 145. There is a secondary screen 150 adjacent to the inner screen 135 on the side of the inner screen 135 opposite the cylindrical catalyst bed 145 and the outer screen 140.

The conical section 130 has a tapered inner screen 155 and an outer screen 160. The outer screen 160 is essentially vertical, while the tapered inner screen 155 is conical. The space between the outer screen 160 and the tapered inner screen 155 forms an annular catalyst bed 165 in the conical section 130.

There is a tertiary screen 170 covering the opening in the conical section 130 formed by the tapered inner screen 155. The tertiary screen 170 prevents any catalyst that escapes from the cylindrical catalyst bed 145 and/or the annular catalyst bed 165 in the conical section 130 from entering the chlorination zone 110. The tertiary screen is located in the reheat zone 107, or at the bottom of the burn zone 105.

The tertiary screen 170 shown in FIG. 1 is a flat screen. The tertiary screen 170 can other forms.

The makeup air 250 from the chlorination zone 110 communicates to the interior of inner screen 135 through the tertiary screen 170 in the conical section 130 of the burn zone 105.

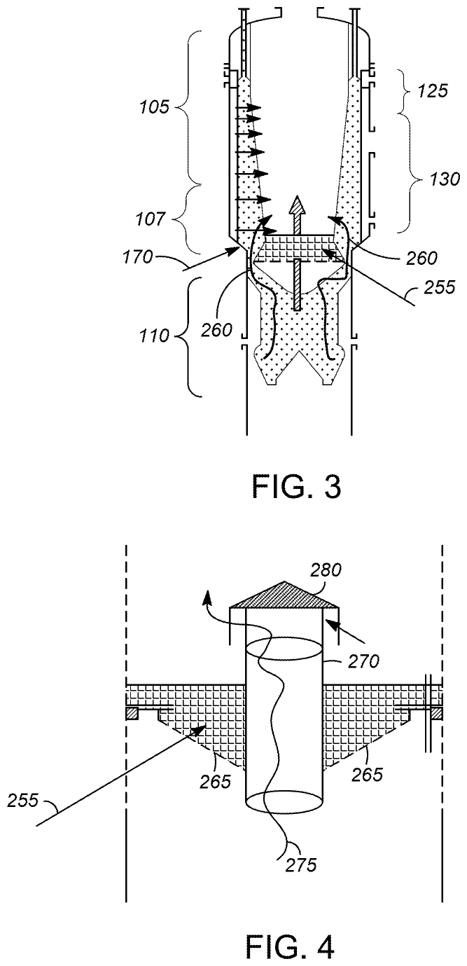

FIG. 3 shows a layer of escaped catalyst bed 255 on top of the tertiary screen 170 in the conical section 130. This increases the pressure drop leading to only a portion of the makeup air 250 communicating from the chlorination zone 110 to the interior of the inner screen 135 through the tertiary screen 170. The remaining portion of the makeup air 260 from the chlorination zone will flow up the annular bed between the inner screen 155 and outer screen 160 at the lower section of the conical section 130 of the burn zone 105. The makeup air is oxygen rich, is typically maintained or controlled in the range of 5 to 21 mole % and the radial regeneration gas flowing from outer screen 160 to the inner screen 155 is typically controlled less than 3 mole %.

This mis-directed flow path of the makeup air 260 contaminates the radial flow of regeneration gas leading to higher oxygen level in the annular catalyst bed 165 in the conical section 130 of the burn zone 105.

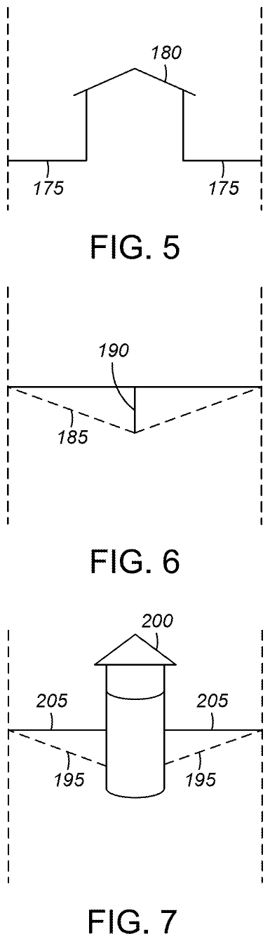

FIG. 4 illustrates a concave tertiary screen 265 comprising a chimney 270 which provides a bypass flow path 275 for the makeup air from the chlorination zone 110 to communicate to the interior to the inner screen 135 without going through the escaped catalyst bed 255 that locates on top of the tertiary screen 265. The chimney hat 280 at the top the chimney 270 prevents escaped catalyst from communicating from the tertiary screen 265 to the chlorination zone 110. The chimney hat 280 and chimney 270 may be made of perforate plate (such as slotted plate, profile wire, screen, punch plate, or mesh wire) allowing makeup gas flow through. These reduce the pressure drop for the makeup gas in the flow path going from the chlorination zone 110 to the interior of the inner screen 135.

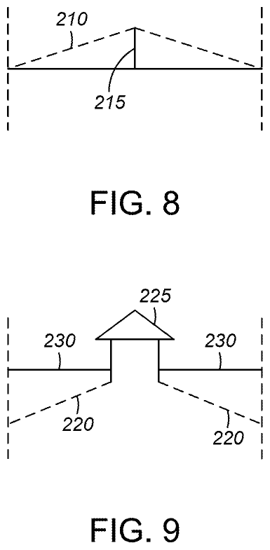

FIGS. 5-9 show other embodiments of the tertiary screen. FIG. 5 shows a flat tertiary screen 175 with a chimney 180. FIG. 6 illustrates a concave tertiary screen 185 with supports 190 for the concave tertiary screen 185. The slope angle of the screen from horizontal may be deeper than the angle of repose of catalyst pills which is typically in the range of 15 to 30 degrees. FIG. 7 shows a concave tertiary screen 195 with a chimney 200 and supports 205 for the chimney 200 and/or the concave tertiary screen 195. The slope angle of the screen from horizontal may be deeper than angle of repose of catalyst pills as discussed above. FIG. 8 illustrates a convex tertiary screen 210 with supports 215 for the convex tertiary screen 210. The slop angle of the screen from horizontal may be deeper than angle of repose of catalyst pills which is typical in the range of 15 to 30 degrees. FIG. 9 shows a convex tertiary screen 220 with a chimney 225 and supports 230 for the chimney 225 and/or the convex tertiary screen 220. The slop angle of the screen from horizontal may be deeper than angle of repose of catalyst pills as discussed above. The chimney could be made of solid rolled plate or perforate plate or screen which reduces the pressure drop when the makeup air travels through from the chlorination zone.

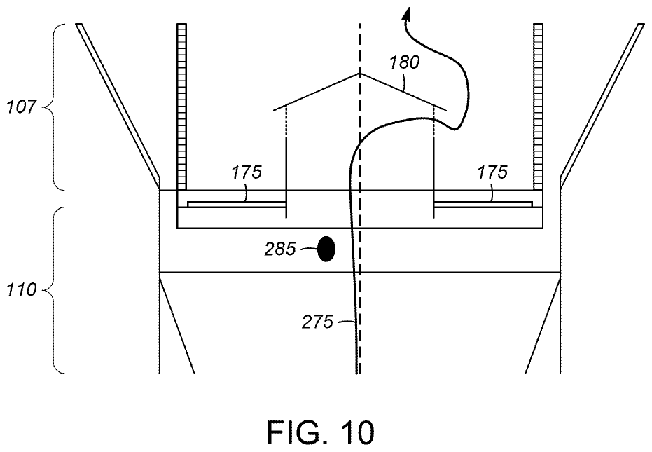

FIG. 10. illustrates one embodiment of a portion of the regeneration tower including the tertiary screen. There is a sensor 285 in the reheat zone 107 between the burn zone 105 and the chlorination zone 110 to monitor the makeup air composition exiting the chlorination zone 110. The sensor 285 can be a carbon dioxide sensor and/or an oxygen sensor. If coke burning occurs in the chlorination zone 110, the drying zone 115, and/or the cooling zone 120, the carbon dioxide level increases, and the oxygen level decreases below 21% due to the combustion of the coked catalyst. When coked catalyst starts to burn, the sensor detects the change in carbon dioxide and/or oxygen level. The use of the high velocity makeup air 275 reduces the detection time of coked catalyst burning in the chlorination zone 110. A inner screen bottom with a chimney directs the makeup air 275 for the sensor probe. Any of the tertiary screens in FIGS. 3-9 could be used. In some embodiments, the sensor 285 can activate an automatic shutdown of the process if the carbon dioxide level increases and/or the oxygen level decreases beyond set limits.

### SPECIFIC EMBODIMENTS

While the following is described in conjunction with specific embodiments, it will be understood that this description is intended to illustrate and not limit the scope of the preceding description and the appended claims.

A first embodiment of the invention is a catalyst regeneration tower comprising a cylindrical section having an inner screen and an outer screen forming an annular catalyst bed therebetween; a conical section having an outer screen and a tapered inner screen forming a catalyst bed therebetween, the conical section positioned below the cylindrical section, the annular catalyst bed connected to the catalyst bed in the conical section; a tertiary screen in the conical section covering an opening defined by the tapered inner screen; and a housing containing the cylindrical section and the conical section. An embodiment of the invention is one, any or all of prior embodiments in this paragraph up through the first embodiment in this paragraph wherein the tertiary screen comprises a flat screen, a flat screen with a chimney, a concave screen, a concave screen with a chimney, a convex screen, or a convex screen with a chimney. An embodiment of the invention is one, any or all of prior embodiments in this paragraph up through the first embodiment in this paragraph wherein the tertiary screen comprises wire mesh, profile wire screen, perforate plate, punch plate, or slotted plate. An embodiment of the invention is one, any or all of prior embodiments in this paragraph up through the first embodiment in this paragraph wherein the cylindrical section has a bed length in a range of 12 to 120 cm. An embodiment of the invention is one, any or all of prior embodiments in this paragraph up through the first embodiment in this paragraph wherein a catalyst volume in the cylindrical section is in a range of 2 to 15% of a volumetric catalyst circulation rate on a one hour basis. An embodiment of the invention is one, any or all of prior embodiments in this paragraph up through the first embodiment in this paragraph wherein the inner screen in the cylindrical section comprises punch plate or slotted plate. An embodiment of the invention is one, any or all of prior embodiments in this paragraph up through the first embodiment in this paragraph wherein a ratio of a length of the inner screen to a width of the annular catalyst bed in the cylindrical section is in a range of 11 to 51. An embodiment of the invention is one, any or all of prior embodiments in this paragraph up through the first embodiment in this paragraph wherein the inner screen in the conical section comprises profile wire. An embodiment of the invention is one, any or all of prior embodiments in this paragraph up through the first embodiment in this paragraph wherein the inner screen has a first side facing the outer screen and a second side facing a center of the cylindrical section, further comprising a secondary screen adjacent to the second side of the inner screen in the cylindrical section and wherein the secondary screen comprises wire mesh. An embodiment of the invention is one, any or all of prior embodiments in this paragraph up through the first embodiment in this paragraph further comprising a burn zone comprising the cylindrical section, and a portion of the conical section; a reheat zone comprising the remaining portion of the conical section below the burn zone; a chlorination zone below the reheat zone; a drying zone below the chlorination zone; a cooling zone below the drying zone; and a carbon dioxide sensor or an oxygen sensor or both between the chlorination zone and the burn zone; wherein the tertiary screen is at a bottom of the burn zone or in the reheat zone; and wherein the housing further contains the chlorination zone, the drying zone, and the cooling zone.

A second embodiment of the invention is a catalyst regeneration tower comprising a burn zone comprising a cylindrical section having an inner screen and an outer screen forming an annular catalyst bed therebetween, wherein the inner screen comprises punch plate, or slotted plate, and wherein the cylindrical section has a bed length in a range of 12 to 120 cm; a first portion of a conical section having an outer screen and a tapered inner screen forming a catalyst bed therebetween, the conical section positioned below the cylindrical section, the annular catalyst bed connected to the catalyst bed in the conical section; a reheat zone comprising a second portion of the conical section below the burn zone; a tertiary screen in the conical section covering an opening defined by the tapered inner screen and wherein the tertiary screen comprises wire mesh, profile wire screen, perforate plate, punch plate, or slotted plate, wherein the tertiary screen is at a bottom of the burn zone or in the reheat zone; a chlorination zone below the burn zone; a drying zone below the chlorination zone; a cooling zone below the drying zone; a housing containing the burn zone, the chlorination zone, the drying zone, and the cooling zone. An embodiment of the invention is one, any or all of prior embodiments in this paragraph up through the second embodiment in this paragraph wherein the tertiary screen comprises a flat screen, a flat screen with a chimney, a concave screen, a concave screen with a chimney, a convex screen, or a convex screen with a chimney. An embodiment of the invention is one, any or all of prior embodiments in this paragraph up through the second embodiment in this paragraph wherein the tertiary screen comprises wire mesh, profile wire screen, perforate plate, punch plate, or slotted plate. An embodiment of the invention is one, any or all of prior embodiments in this paragraph up through the second embodiment in this paragraph wherein a catalyst volume in the cylindrical section is in a range of 2 to 15% of a volumetric catalyst circulation rate on a one hour basis. An embodiment of the invention is one, any or all of prior embodiments in this paragraph up through the second embodiment in this paragraph wherein a ratio of a length of the inner screen to a width of an annulus between the inner screen and the outer screen in the cylindrical section is in a range of 11 to 51. An embodiment of the invention is one, any or all of prior embodiments in this paragraph up through the second embodiment in this paragraph wherein the inner screen in the conical section comprises profile wire. An embodiment of the invention is one, any or all of prior embodiments in this paragraph up through the second embodiment in this paragraph the inner screen has a first side facing the outer screen and a second side facing a center of the cylindrical section, further comprising a secondary screen adjacent to the second side of the inner screen in the cylindrical section and wherein the secondary screen comprises wire mesh.

A third embodiment of the invention is a catalyst regeneration tower comprising a cylindrical section having an inner screen and an outer screen forming an annular catalyst bed therebetween, wherein the inner screen has a first side facing the outer screen and a second side facing a center of the cylindrical section, and further comprising a secondary screen adjacent to the second side of the inner screen and wherein the secondary screen comprises wire mesh, and wherein the cylindrical section has a bed length in a range of 12 to 120 cm; a conical section having an outer screen and a tapered inner screen forming a catalyst bed therebetween, the conical section positioned below the cylindrical section, the annular catalyst bed connected to the catalyst bed in the conical section; a tertiary screen in the conical section covering an opening defined by the tapered inner screen and wherein the tertiary screen comprises wire mesh, profile wire screen, perforate plate, punch plate, or slotted plate; and a housing containing the cylindrical section and the conical section. An embodiment of the invention is one, any or all of prior embodiments in this paragraph up through the third embodiment in this paragraph wherein the inner screen comprises punch plate, or slotted plate; or the tertiary screen comprises wire mesh, profile wire screen, perforate plate, punch plate, or slotted plate; or both. An embodiment of the invention is one, any or all of prior embodiments in this paragraph up through the third embodiment in this paragraph further comprising a burn zone comprising the cylindrical section, and a portion of the conical section; a reheat zone comprising the remaining portion of the conical section below the burn zone; a chlorination zone below the reheat zone; a drying zone below the chlorination zone; a cooling zone below the drying zone; and a carbon dioxide sensor or an oxygen sensor or both between the chlorination zone and the burn zone; wherein the tertiary screen is at a bottom of the burn zone or in the reheat zone; and wherein the housing further contains the chlorination zone, the drying zone, and the cooling zone.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A catalyst regeneration tower comprising:
a cylindrical section having an inner screen and an outer screen forming an annular catalyst bed therebetween;
a conical section having an outer screen and a tapered inner screen forming a catalyst bed therebetween, the conical section positioned below the cylindrical section, the annular catalyst bed connected to the catalyst bed in the conical section;
a tertiary screen in the conical section covering an opening defined by the tapered inner screen; and
a housing containing the cylindrical section and the conical section.

2. The catalyst regeneration tower of claim 1 wherein the tertiary screen comprises a flat screen, a flat screen with a chimney, a concave screen, a concave screen with a chimney, a convex screen, or a convex screen with a chimney.

3. The catalyst regeneration tower of claim 1 wherein the tertiary screen comprises wire mesh, profile wire screen, perforate plate, punch plate, or slotted plate.

4. The catalyst regeneration tower of claim 1 wherein the cylindrical section has a bed length in a range of 12 to 120 cm.

5. The catalyst regeneration tower of claim 1 wherein a catalyst volume in the cylindrical section is in a range of 2 to 15% of a volumetric catalyst circulation rate on a one hour basis.

6. The catalyst regeneration tower of claim 1 wherein the inner screen in the cylindrical section comprises punch plate or slotted plate.

7. The catalyst regeneration tower of claim 1 wherein a ratio of a length of the inner screen to a width of the annular catalyst bed in the cylindrical section is in a range of 1:1 to 5:1.

8. The catalyst regeneration tower of claim 1 wherein the inner screen in the conical section comprises profile wire.

9. The catalyst regeneration tower of claim 1 wherein the inner screen has a first side facing the outer screen and a second side facing a center of the cylindrical section, further comprising a secondary screen adjacent to the second side of the inner screen in the cylindrical section and wherein the secondary screen comprises wire mesh.

10. The catalyst regeneration tower of claim 1 further comprising:
a burn zone comprising the cylindrical section, and a portion of the conical section;
a reheat zone comprising the remaining portion of the conical section below the burn zone;
a chlorination zone below the reheat zone;
a drying zone below the chlorination zone;
a cooling zone below the drying zone; and
a carbon dioxide sensor or an oxygen sensor or both between the chlorination zone and the burn zone;
wherein the tertiary screen is at a bottom of the burn zone or in the reheat zone; and
wherein the housing further contains the chlorination zone, the drying zone, and the cooling zone.

11. A catalyst regeneration tower comprising:
a burn zone comprising:
a cylindrical section having an inner screen and an outer screen forming an annular catalyst bed therebetween, wherein the inner screen comprises punch plate, or slotted plate, and wherein the cylindrical section has a bed length in a range of 12 to 120 cm;
a first portion of a conical section having an outer screen and a tapered inner screen forming a catalyst bed therebetween, the conical section positioned below the cylindrical section, the annular catalyst bed connected to the catalyst bed in the conical section;
a reheat zone comprising a second portion of the conical section below the burn zone;
a tertiary screen in the conical section covering an opening defined by the tapered inner screen and wherein the tertiary screen comprises wire mesh, profile wire screen, perforate plate, punch plate, or slotted plate, wherein the tertiary screen is at a bottom of the burn zone or in the reheat zone;
a chlorination zone below the burn zone;
a drying zone below the chlorination zone;
a cooling zone below the drying zone;
a housing containing the burn zone, the chlorination zone, the drying zone, and the cooling zone.

12. The catalyst regeneration tower of claim 11 wherein the tertiary screen comprises a flat screen, a flat screen with a chimney, a concave screen, a concave screen with a chimney, a convex screen, or a convex screen with a chimney.

13. The catalyst regeneration tower of claim 11 wherein the tertiary screen comprises wire mesh, profile wire screen, perforate plate, punch plate, or slotted plate.

14. The catalyst regeneration tower of claim 11 wherein a catalyst volume in the cylindrical section is in a range of 2 to 15% of a volumetric catalyst circulation rate on a one hour basis.

15. The catalyst regeneration tower of claim 11 wherein a ratio of a length of the inner screen to a width of an annulus between the inner screen and the outer screen in the cylindrical section is in a range of 1:1 to 5:1.

16. The catalyst regeneration tower of claim 11 wherein the inner screen in the conical section comprises profile wire.

17. The catalyst regeneration tower of claim 11 the inner screen has a first side facing the outer screen and a second side facing a center of the cylindrical section, further comprising a secondary screen adjacent to the second side of the inner screen in the cylindrical section and wherein the secondary screen comprises wire mesh.

18. A catalyst regeneration tower comprising:
a cylindrical section having an inner screen and an outer screen forming an annular catalyst bed therebetween, wherein the inner screen has a first side facing the outer screen and a second side facing a center of the cylindrical section, and further comprising a secondary screen adjacent to the second side of the inner screen and wherein the secondary screen comprises wire mesh, and wherein the cylindrical section has a bed length in a range of 12 to 120 cm;
a conical section having an outer screen and a tapered inner screen forming a catalyst bed therebetween, the conical section positioned below the cylindrical section, the annular catalyst bed connected to the catalyst bed in the conical section;
a tertiary screen in the conical section covering an opening defined by the tapered inner screen and wherein the tertiary screen comprises wire mesh, profile wire screen, perforate plate, punch plate, or slotted plate; and
a housing containing the cylindrical section and the conical section.

19. The catalyst regeneration tower of claim 18 wherein:
the inner screen comprises punch plate, or slotted plate; or
the tertiary screen comprises wire mesh, profile wire screen, perforate plate, punch plate, or slotted plate;
or both.

20. The catalyst regeneration tower of claim 18further comprising:
a burn zone comprising the cylindrical section, and a portion of the conical section;
a reheat zone comprising the remaining portion of the conical section below the burn zone;
a chlorination zone below the reheat zone;
a drying zone below the chlorination zone;
a cooling zone below the drying zone; and
a carbon dioxide sensor or an oxygen sensor or both between the chlorination zone and the burn zone;
wherein the tertiary screen is at a bottom of the burn zone or in the reheat zone; and
wherein the housing further contains the chlorination zone, the drying zone, and the cooling zone.
